(19) United States
(12) Patent Application Publication
(10) Pub. No.: US 2018/0178630 A1
(43) Pub. Date: Jun. 28, 2018

(54) METHOD FOR HEATING, AND HEATING SYSTEM

(71) Applicant: CONTINENTAL AUTOMOTIVE GMBH, Hannover (DE)

(72) Inventors: Egor Sawazki, Regensburg (DE); Martin Brüll, Barbing (DE)

(73) Assignee: CONTINENTAL AUTOMOTIVE GMBH, Hannover (DE)

(21) Appl. No.: 15/894,336

(22) Filed: Feb. 12, 2018

Related U.S. Application Data
(63) Continuation of application No. PCT/EP2016/068955, filed on Aug. 9, 2016.

(30) Foreign Application Priority Data
Aug. 13, 2015 (DE) 10 2015 215 424.6

(51) Int. Cl. B60H 1/22; H05B 1/02; B60T 1/10

(52) U.S. Cl. CPC B60H 1/2218; B60H 1/2225; H05B 1/0236; B60H 2001/2265; B60H 2001/2275; B60H 2001/2237; B60T 1/10

(57) ABSTRACT

A method for heating the interior of a motor vehicle and a heating system are described. In the method, electrical energy stored or generated in the motor vehicle or electrical energy fed from an external energy source is fed to an electrothermal transducer and is converted there to thermal energy, which is supplied to a carrier medium for the thermal energy. An electrothermal transducer is used, which is temporarily operated at a higher heating power in the heating-up phase than in the subsequent continuous operation. In this way, the motor vehicle interior is heated up significantly quicker than in the known methods.

### CROSS-REFERENCE TO RELATED APPLICATIONS

This application claims the benefit of PCT Application PCT/DE2016/068955, filed Aug. 9, 2016, which claims priority to German Patent Application 10 2015 215 424.6, filed Aug. 13, 2015. The disclosures of the above applications are incorporated herein by reference.

### FIELD OF THE INVENTION

The present invention relates to a method for heating the interior of a motor vehicle, in which the electrical energy stored or generated in the motor vehicle or electrical energy fed from an external energy source is fed to an electrothermal transducer and is converted there to thermal energy, which is supplied to a carrier medium for the thermal energy.

### BACKGROUND OF THE INVENTION

It is known to heat up the interior of motor vehicles using an electrothermal transducer (electric heater) at cold ambient temperatures. Depending on the vehicle class, the maximum heating power is restricted here to approximately 5-7 kW, which, at very low temperatures, corresponds to the required thermal power in the steady-state mode.

In this case, particularly at low ambient temperatures, the interior heats up quite slowly. The appropriate comfort for the occupant is only reached after a certain amount of time and, at very low temperatures, is not reached at all. Furthermore, the low heating power only slowly de-ices the windshield of the motor vehicle. This is a safety-technical disadvantage. Particularly fast heating-up of the vehicle interior and particularly fast de-icing of the windshield are therefore desirable.

The vehicle interior is usually heated up using a transducer, which converts electrical power to thermal power. The generated thermal energy is supplied to a carrier medium for the thermal energy, wherein the carrier medium for the thermal energy may be a cooling medium or air. When using a cooling medium, the thermal energy is still provided to the vehicle interior by way of a cooling medium/air heat exchanger. At present, the maximum power for the heating-up process is restricted to approximately 7 kW (for example in the case of a PTC heater). As stated above, this leads to a relatively slow progression of the heating process.

The electrical energy for the heating process is usually extracted from the vehicle battery.

DE 10 2012 004 008 A1 discloses a method for operating a temporarily or sectionally electromotively driven vehicle having an electrical energy store, a low-temperature circuit and a refrigeration circuit, which are thermally coupled to one another. In this case, during a braking process, recuperated electrical energy is supplied to a compressor of the refrigeration circuit or to a braking resistor depending on an external temperature and/or on a state of charge of the electrical energy store. The recuperated electrical energy is converted to thermal energy by means of the braking resistor, the thermal energy being able to be fed in a conventional manner to a vehicle interior for the purpose of heating.

### SUMMARY OF THE INVENTION

The method therefore proposes heating the motor vehicle interior using a braking resistor to which the recuperated electrical energy is fed during a braking process,

The present invention proceeds from a known method for heating the interior of a motor vehicle, in which the maximum power of an electrothermal transducer for the heating-up process is restricted to 7 kW, The invention is based on the object of providing a method of the type mentioned at the outset using which particularly fast heating-up of the vehicle interior is possible.

This object is achieved in accordance with the invention in a method of the specified type by virtue of the fact that the electrothermal transducer is temporarily operated at a higher heating power of >7 kW, in particular of 30-50 kW, in the heating-up phase than in the subsequent continuous operation and is temporarily supplied with the electrical energy required for the higher heating power,

The heating-up process is carried out in accordance with the invention using a power transducer, in particular a power resistor, which may temporarily deliver a higher power, for example 30 kW or more. In this way, the heating-up process of the interior or thawing of the windshield is carried out significantly more quickly than in the prior art, in which electrothermal transducers operate at a maximum heating power of 7 kW, which also corresponds to the continuous power of the transducers. The electrothermal transducer used in accordance with the invention is operated temporarily, for example over a period of 10-20 sec, at a power in the peak range. The peak operation takes place in the heating-up phase, preferably at the beginning of a desired heating period. From an energy point of view, not much more energy is consumed in this fast heating-up than in the prior art. Although more power is required, this is over a shorter time. Although less power is required in heating-up processes of the prior art, the heating-up process is much longer.

In the ideal case, no more energy is required for the operating mode according to the invention than for the classic operating mode of the prior art.

The method according to the invention is preferably carried out in an electric vehicle or a hybrid vehicle. In other words, the method is preferably used in a temporarily or sectionally electromotively driven vehicle. The method according to the invention may also otherwise be carried out in vehicles with an internal combustion engine, wherein, in this case, however, the efficiency in electrically operated vehicles (with the possibility of recuperation) should be better.

Air or a cooling medium is used as the carrier medium for the thermal energy. In the case of air, the electrothermal transducer emits the thermal energy directly to the air of the interior of a motor vehicle in order to heat the interior in this way. If a cooling medium is used as the carrier medium for the thermal energy, the thermal energy is emitted from the electrothermal transducer to the cooling medium, which then heats the air of the interior by means of a heat exchanger.

The electrical energy required to operate the electrothermal transducer at the higher heating power is extracted from electrical energy stored in the motor vehicle or generated thereby. In this case, in one embodiment, the electrical energy is extracted from the vehicle battery. This is controlled, for example, in such a way that energy for the heating-up process is extracted only when the battery has a specific state of charge in order to prevent excessive discharging of the battery. In another embodiment of the invention, the electrical energy required for the heating-up process is generated by recuperation and stored or converted directly to thermal energy. This is realized, for example, by means of a braking resistor. In this case, the kinetic energy of the vehicle generated during the braking process is converted to electrical energy, for example, which is fed to the braking resistor and is converted to thermal energy by the braking resistor. For example, the energy required for the heating-up process may then be extracted either from the battery or from the braking resistor using an appropriate controller.

An electrothermal transducer may also be used, for example, which is fed both by the vehicle battery and using electrical energy generated by recuperation. In this case, a suitable controller may ensure one type of energy supply or the other depending on requirement. As a further alternative, the transducer could also access electrical energy fed from an external energy source.

One method variant has proven to be particularly suitable, in which the electrothermal transducer is temporarily operated at the higher heating power at the beginning of a heating period and then is switched to continuous operation at a lower heating power. It has been shown that the temporary heating-up, for example over a short period of 10-20 sec, may achieve a considerable heating effect, which immediately leads to a certain degree of heating-up of the motor vehicle interior and hence to an increase in comfort. The electrothermal transducer is therefore temporarily supplied with the electrical energy required for the higher heating power at the beginning of a heating period and then is supplied with electrical energy required for a lower heating power.

The invention further relates to a heating system for a motor vehicle having a device for storing, generating or feeding electrical energy and having an electrothermal transducer to which the electrical energy is fed and which electrothermal transducer converts the electrical energy to thermal energy and supplies the thermal energy to a carrier medium for the thermal energy.

The heating system is distinguished according to the invention in that the electrothermal transducer is configured in such a way that it is temporarily operated at a higher heating power of >7 kW, in particular of 30-50 kW, in the heating-up phase and in that the heating system has a supply system for the electrothermal transducer, which supply system supplies the transducer with the electrical energy required for the temporary higher heating power from the device for generating, storing or feeding electrical energy.

The electrothermal transducer supplies the generated thermal energy to a carrier medium to heat up the motor vehicle interior. In this case, the carrier medium may be air. When the carrier medium is a cooling medium, the system has a heat exchanger to transfer the thermal energy from the cooling medium to the air to be heated.

The electrical energy required by the electrothermal transducer is provided by the battery of the vehicle or by a recuperation system. The recuperation system may have, for example, a braking resistor, which converts the generated electrical energy to thermal energy. Electrical energy may also be fed from an external energy source.

The heating system preferably has a control system, which switches the electrothermal transducer temporarily to the higher heating power and then to continuous operation at the lower heating power.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail below with reference to an exemplary embodiment in connection with the drawing. In the drawing:

FIG. 1 shows a block diagram that shows the most important constituent parts of a heating system of a motor vehicle; and

FIG. 2 shows a graph that shows the heating power, the cooling medium temperature and the interior temperature over time for a system according to the invention (new system) and a system according to the prior art (old system).

### DETAILED DESCRIPTION OF THE PREFERRED EMBODIMENTS

The following description of the preferred embodiment(s) is merely exemplary in nature and is in no way intended to limit the invention, its application, or uses.

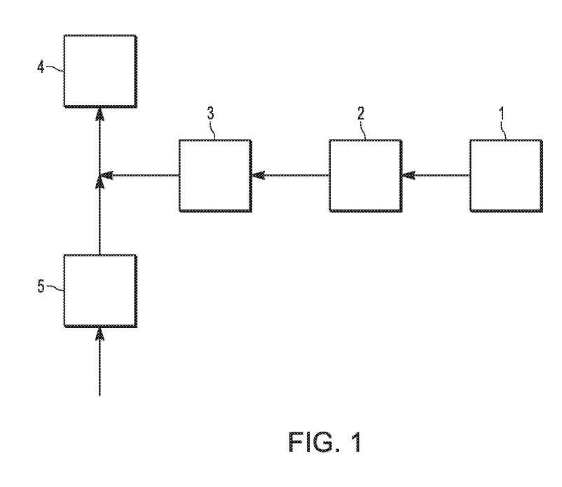

The system schematically illustrated in FIG. 1 has a vehicle battery 1 and an electrothermal transducer 2, which converts electrical energy to thermal energy. When a vehicle interior 4 is intended to be heated, the electrothermal transducer 2 is actuated. In this case, the electrothermal transducer is a power transducer (power resistor), which temporariy delivers a higher power (for example 30 kW or more) in order to heat up the interior 4 of the motor vehicle as quickly as possible.

In the embodiment illustrated here, the heating system further has a cooling medium/air heat exchanger 3. The thermal energy delivered by the electrothermal transducer is fed to a cooling medium, from which the thermal energy in the heat exchanger 3 is transferred to the air of the motor vehicle interior 4 to be heated.

The system is further provided with a braking resistor 5, which in this case also acts as an electrothermal transducer. The vehicle that has the heating system illustrated here is an electric vehicle in which, during a braking process, the associated electric motor is operated by generator and provides electrical energy by recuperation to the braking resistor 5, which converts the electrical energy to thermal energy. In this case, the braking resistor is also a power transducer, which temporarily delivers a higher power. The air in the motor vehicle interior 4 is likewise heated up using the generated thermal energy.

In the heating system illustrated here, a control system (not illustrated) may, for example, remove thermal energy from the braking resistor 5 when the thermal energy accumulates or extract the required thermal energy from the vehicle battery 1 when no thermal energy is generated by recuperation. Both systems may also operate together.

Instead of the electrical transducer 2 and the braking resistor 5 described above, a single electrothermal transducer may also be provided, which is supplied with electrical energy from the vehicle battery or with electrical energy generated by recuperation (where applicable also using electrical energy fed from outside), wherein a control system may control the type of energy feed as required.

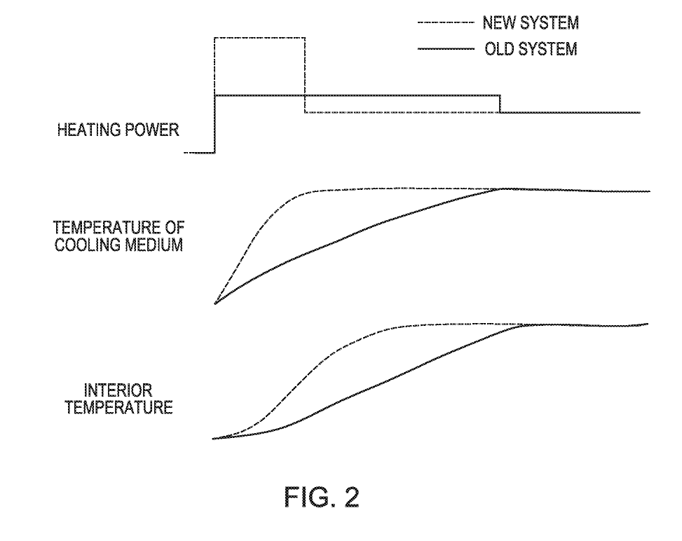

The top graph of FIG. 2 shows the heating power of the system according to the invention (illustrated using dashes) and of a system of the prior art (illustrated using a solid line). It is seen that the electrothermal transducer or braking resistor is temporarily operated at a very high power at the beginning of the heating period, with the result that the motor vehicle interior heats up quickly. The heating power is in this case approximately double the magnitude of that of a known electric heater whose maximum power is restricted to approximately 5-7 kW. Whereas the known electric heater is operated constantly (at continuous power), the electrothermal transducer provided in accordance with the invention is stopped after a relatively short period in high-power operation and is operated further at a power below that of the conventional electric heater until the end of the heating period.

The center graph of FIG. 2 shows the profile of the cooling medium temperature in the system according to the invention (illustrated using dashes) and in a system of the prior art (illustrated using a solid line). It is seen that in the system according to the invention the cooling medium temperature increases very quickly to a peak value and then remains approximately constant. In contrast, in the prior art, the temperature increases only relatively slowly.

The same applies to the interior temperature shown in the bottom graph. In this case, too, the temperature in the system according to the invention, illustrated using dashes, increases much more steeply than the temperature in the known system (illustrated using a solid line).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for heating the interior of a motor vehicle,
providing an electrothermal transducer;
providing a carrier medium; and
providing a heating-up phase, during which the electrothermal transducer is operated at a higher heating power;
transferring electrical energy to the electrothermal transducer;
converting the electrical energy to thermal energy;
supplying the thermal energy to the carrier medium;
temporarily operating the electrothermal transducer at the higher heating power of >7 kW, in particular of 30-50 kW, during the heating-up phase than in the subsequent continuous operation of the electrothermal transducer;
supplying the electrothermal transducer with the electrical energy required for the higher heating power.

2. The method of claim 1_{;} further comprising the steps of:
providing an external energy source;
transferring the electrical energy to the electrothermal transducer from the external energy source.

3.The method of claim 1, further comprising the steps of:
generating electrical energy in the motor vehicle;
transferring the electrical energy to the electrothermal transducer from the motor vehicle.

4. The method of claim 1, further comprising the steps of providing the electrothermal transducer to be designed for a continuous power of 5-7 kW is used, and being able to temporarily produce a peak power of >7 kW.

5. The method of claim 1, further comprising the steps of providing the motor vehicle to be one selected from the group consisting of an electric vehicle and a hybrid vehicle.

6. The method of claim 1, further comprising the steps of providing the carrier medium to be one selected from the group consisting of air and a cooling medium.

7. The method of claim 1, further comprising the steps of extracting the electrical energy from the vehicle battery.

8. The method of claim 1, further comprising the steps of:
generating the electrical energy by recuperation;
converting the electrical energy to thermal energy.

9. The method of claim 8, further comprising the steps of:
providing the electrothermal transducer to be a braking resistor;
generating the thermal energy is generated by using the braking resistor.

10. The method of claim 1, further comprising the steps of:
providing a heating period;
temporarily supplying the electrothermal transducer with the electrical energy required for the higher heating power at the beginning of the heating period;
supplying the electrothermal transducer with electrical energy required for a lower continuous power after the heating period.

11. A heating system for a motor vehicle, comprising:
a device for storing, generating or feeding electrical energy;
a carrier medium;
an electrothermal transducer being part of the device, the electrothermal transducer capable of being operated in a heating-up phase, the electrothermal transducer to which the electrical energy is fed and which the electrothermal transducer converts the electrical energy to thermal energy and supplies the thermal energy to the carrier medium;
a supply system in communication with the electrothermal transducer;
wherein the electrothermal transducer is configured such that the electrothermal transducer is temporarily operated at a higher heating power of >7 kW, in particular of 30-50 kW, in the heating-up phase than in the subsequent continuous operation, and the supply system supplies the electrothermal transducer with the electrical energy required for the temporary higher heating power from the device for generating, storing or feeding electrical energy.

12. The heating system of claim 9, the heating system further comprising a heat exchanger for a cooling medium, wherein the cooling medium is used as the carrier medium.

13. The heating system of claim 9, further comprising a recuperation system for generating electrical energy, wherein the heating system is connected to the recuperation system.

14. The heating system of claim 11, the recuperation system further comprising:
a braking resistor, the braking resistor used as the electrothermal transducer;
wherein the braking resistor converts the generated electrical energy to thermal energy.

15. The heating system of claim 9, further comprising:
a control system being part of the heating system;
wherein the control system switches the electrothermal transducer temporarily to the higher heating power and then to continuous operation at a lower heating power.
